(19) United States
(12) Patent Application Publication
(10) Pub. No.: US 2005/0177461 A1
(43) Pub. Date: Aug. 11, 2005

(54) System and method of internet advertising

(76) Inventors: Craig Alan Rosefelt, Waukesha, WI (US); Sharon Lee Rosefelt, Longwood, FL (US); Margaret Ann Maliborski, Glendale, WI (US)

Correspondence Address: GEHRKE & ASSOCIATES, S.C., 123 N. 86th ST, WAUWATOSA, WI, 53226, US

(21) Appl. No.: 10/753,579

(22) Filed: Jan. 8, 2004

(51) Int. Cl. G06F 17/60

(52) U.S. Cl. 705/27

(57) ABSTRACT

A method and system for advertising on the internet includes a storage medium that contains a key associated with at least one characteristic of a potential customer. The storage medium is distributed in the bricks-and-mortar world to the potential customer. The system further includes a communication link to the internet, and the key is communicated over the communication link to a website on the internet. An advertisement database that is connected to the website displays a set of advertisements stored in the advertisement database on the website to the potential customer based on the characteristics of the potential customer associated with the key. A selection device that is integrated into the website evaluates the key and selects the set of advertisements to be displayed based on predefined criteria.

### BACKGROUND OF THE INVENTION

1. Field of the Invention

The present invention relates generally to a method of advertising on the Internet. In particular, the present invention relates to a system that bridges the gap between the brick and mortar world and the virtual world on the internet by targeting a person to receive a particular advertisement based on a set of demographics after a physical interaction with the targeted person.

2. Discussion of the Related Art

Historically, the Internet had its build out in the 1990's and that included most commerce being represented on the Internet via web sites. During that time everyone believed the Internet would revolutionize the way business was conducted, and businesses would realize a vast increase in business transactions. This has not happened.

Other than the few dominant Internet sites, the rest of the business world does very little commerce or advertising over the Internet. To date, the Internet has yet to make meaningful usage of the common business's web site. It is hard to even conceptualize most of these Internet sites as places for commerce, let alone a good representation of their general business at hand.

Even though there are a few key commerce players on the Internet (AOL, Yahoo, Ebay and Amazon.com), there is no structure or business model in place that links, for the consumer or business, the real world to the virtual world for commercial intent.

The current players in the Internet arena have failed to facilitate commerce and advertising to the common business and to a highly targeted audience. Therefore, there is a need to revolutionize the way business is currently performed on the Internet. There is also a need to entice and drive people and businesses to use the Internet for commerce, advertising, information and communications.

Internet advertising has stagnated into attracting clients to companies in a select few industries such as home refinancing and brokerage services. Most of the industry in our country and the world has been eliminated from using the Internet effectively as a tool for advertising and commerce because the Internet has no geographical control on where advertising is directed and no way to target an audience effectively.

Even if an Internet company could create geographical boundaries for Internet advertising, today's Internet companies are centrally located in the brick and mortar world and are incapable of reaching out and soliciting the business community across geographical boundaries.

What is needed, therefore, to overcome these inherent limitations of advertising on the Internet is a method of Internet advertising that is instantaneously presented to a highly targeted audience with specific geographical boundaries by combining an Internet advertising base with particular product lines.

### SUMMARY OF THE INVENTION

A method and system for advertising on the internet includes a storage medium that contains a key associated with at least one characteristic of a potential customer. The storage medium is distributed in the bricks-and-mortar world to the potential customer. The system further includes a communication link to the internet, and the key is communicated over the communication link to a website on the internet. An advertisement database that is connected to the website displays a set of advertisements stored in the advertisement database on the website to the potential customer based on the characteristics of the potential customer associated with the key. A selection device that is integrated into the website evaluates the key and selects the set of advertisements to be displayed based on predefined criteria.

According to another aspect of the present invention, a system for advertising on the internet includes a franchise building, a communication link, an advertisement database, and a selection device. The franchise building is in the bricks-and-mortar world and distributes a key to a potential customer. The key is associated with at least one characteristic of the potential customer. The communication link is used to communicate the key a website on the internet. The advertisement database is connected to the website, and a set of advertisements stored in the advertisement database is displayed on the website to the potential customer based on the characteristic of the potential customer associated with the key. The selection device is integrated into the website, and it evaluates the key and selects the set of advertisements to be displayed based on predefined criteria.

According to yet another aspect of the present invention, a method of advertising on the internet includes the steps of distributing a key to a potential customer wherein the key is associated with at least one characteristic of the potential customer, communicating the key to a website on the internet, and displaying a set of advertisements on the website to the potential customer based on the characteristic of the potential customer associated with the key.

### BRIEF DESCRIPTION OF THE DRAWINGS

A clear understanding of the various advantages and features of the present invention, as well as the construction and operation of conventional components and mechanisms associated with the present invention, will become more readily apparent by referring to the exemplary, and therefore non-limiting, embodiments illustrated in the following drawings which accompany and form a part of this patent specification.

FIG. 1 is an illustration of an advertisement on the inside or outside of the sleeve for a CD according to the preferred embodiment of the present invention;

FIG. 2 is an illustration of an advertisement on a memory stick according to the preferred embodiment of the present invention;

FIG. 3 is an illustration of an advertisement on a floppy disk according to the preferred embodiment of the present invention;

FIG. 4 is an illustration of an advertisement on an electronic business card according to the preferred embodiment of the present invention;

FIG. 5 an illustration of an advertisement contained in and on a CD according to the preferred embodiment of the present invention;

FIG. 6 is an illustration of a database associated with the internet advertising system according to the preferred embodiment of the present invention;

FIG. 7 is an illustration of the bridge between the Internet and the business community according to the preferred embodiment of the present invention;

FIG. 8 is an illustration of advertising on the web site according to the preferred embodiment of the present invention;

FIG. 9 is an illustration of regional/franchise offices and businesses within separate geographical zones according to the preferred embodiment of the present invention;

FIG. 10 is an illustration of a web portal according to the preferred embodiment of the present invention;

FIG. 11 is an illustration of the organization of a headquarters according to the preferred embodiment of the present invention;

FIG. 12 is an illustration of products offered through the web portal according to the preferred embodiment of the present invention;

FIG. 13 is an illustration of brick-and-mortar franchises interfacing with the website according to the preferred embodiment of the present invention;

FIG. 14 is an illustration of virtual franchises interfacing with the website according to an alternative embodiment of the present invention;

FIG. 15 is an illustration of interfacing with the website without using franchises according to an alternative embodiment of the present invention;

FIG. 16 is an illustration of franchises interacting directly with the website according to an alternative embodiment of the present invention; and

FIG. 17 is an illustration of viewing advertising on a storage medium without interfacing with the website according to an alternative embodiment of the present invention.

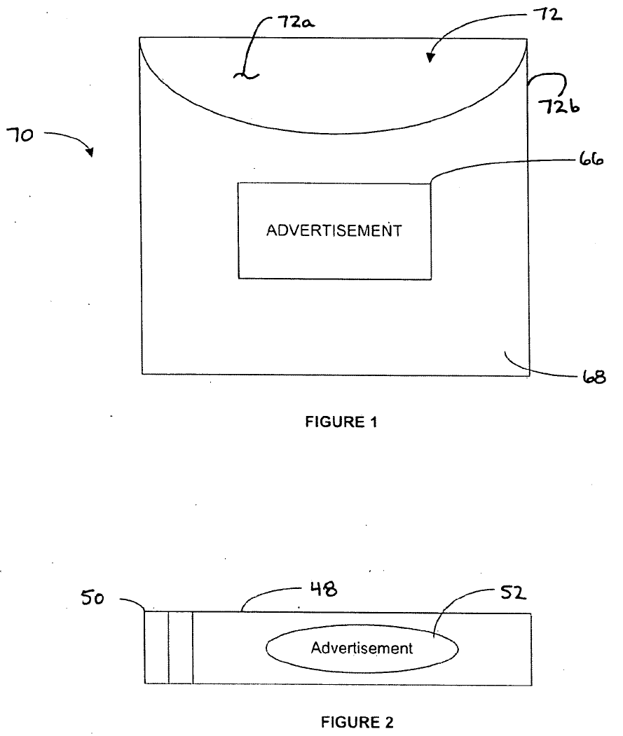

### DETAILED DESCRIPTION OF THE PREFERRED EMBODIMENTS

The Internet is a vast never-ending piece of undeveloped real estate with a few Internet companies here and there that have placed their stakes in the ground. In particular, the revenue generation capability of the Internet has yet to be developed. A key component in this development is the ability of a company to generate advertising revenue which is directly related to the ability of a company to target its advertising efforts.

In this regard, the present invention defines, designs and franchises out sections of the Internet at a time. The present system assembles these sections into online cooperatives between local business communities and local residents that occupy them. In turn, these cooperatives become the entry and exit points for millions of Internet users across the globe.

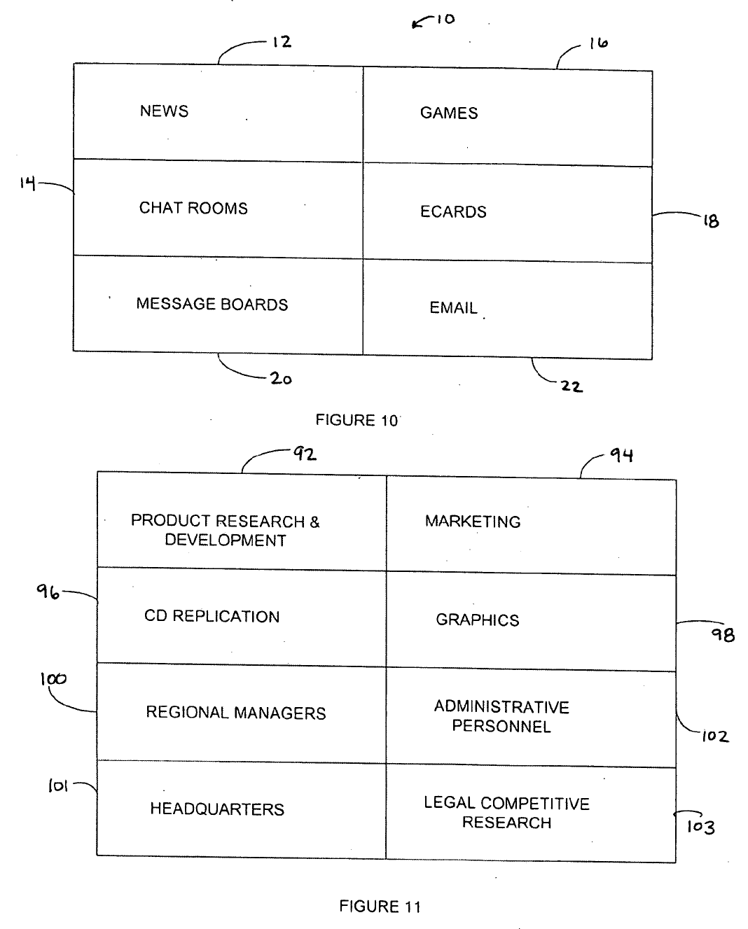

Referring to FIG. 10, a Web Portal 10 for the Internet includes free news 12, chat rooms 14, games 16, E-cards 18, message boards 20, email 22, in addition to other common services that other portals currently provide. Web portal 10 also includes a variety of separate products that transcend boundaries between the virtual and real world.

Web portal 10 is based on not waiting for people to establish an Internet connection. In this regard, a method of advertising on the Internet including waiting for potential customers to do whatever it is that they like to do, in the real world, and then establishing contact with these potential customers in the real world.

As illustrated in FIG. 9, a satellite office 24 is the physical structure binding the two worlds together. There is one owner of office 24 in each major city in every country throughout the world, including suburban and rural areas. Large cities have several offices but there is one owner per city. This allows a company to engage and maintain contact with the individual businesses 26 and sell the product lines and Internet advertising services.

For example, in a large city, one geographical cell is defined by a set of boundaries 28, 30, 32, and 34, and another geographical cell is defined by a set of boundaries 36, 38 and 40. Both cells share geographical boundary 32 and there is one satellite office 24 in one cell and multiple in the other.

While having a physical presence in the franchise area is preferred, it may be that in some instances a virtual franchise office is sufficient. All activities and services can be provided virtually and in combination with representatives physically located in the bounded area. Therefore, alternative embodiments of the present invention include having virtual franchises interfacing with a website, having advertising delivered only on a memory device without relying on a website or any franchises, relying only on a website, or relying only on a memory device and a website without any franchises.

In the preferred embodiment of the present invention, an advertiser can advertise across geographic boundaries and/or franchise areas, thereby permitting one advertiser to have multiple advertising relationships.

Web portal 10 includes an internet operating system (IOS) that includes tools to makes the user's entry access point to the Internet through portal 10 more useful and appealing than any other entry point. The IOS provides geographically based, user selected items that appear on the personalized entry access point to the Internet. When a user enters portal 10 using the IOS, the user is automatically logged right into their own personalized geographical area of the Internet, with access to any other part of the Internet.

Users can access portal 10's IOS through any communications device, including a dumb communication device and/or dumb hub, capable of accessing the Internet, to gain access to their customized entry access point to the Internet, geographical area of the Internet, access to the entire Internet and all stored files and information they would normally store on there own computers. The IOS includes all standard tools, increased storage, and other options that current operating systems offer.

The advantages of using portal 10's IOS include remote access to all of the users' stored information from anywhere, with any type of device; users can personalize their entry point access to the Internet, reflecting their own brick and mortar communities; users can supplement their own communication device, tools, access and storage capabilities with portal 10's IOS offerings.

Turning to FIG. 5, CD 42 includes a surface 44 for placing an advertisement label for CD 42. As is well-known in the industry, CD 42 includes an aperture 46 in the middle of CD 42. CD 42 is the key that links advertisers to their customers and establishes geographical and demographic boundaries for Internet advertising. CD 42 literally creates multiple business cooperatives throughout every community. In the present invention, demographic information includes how the consumer uses the products and websites, zip, telephone number, city, state, country, time zone, hobbies, activities, profession, education, international connection identification, cookies, etc.

The physical linking provided by CD 42 develops local and international business communities, directly targets ethnic communities, develops communities for the older age groups, encourages new activities and participation over the Internet, and puts the Internet into everyone's lives and gives them good reason to interact with the Internet.

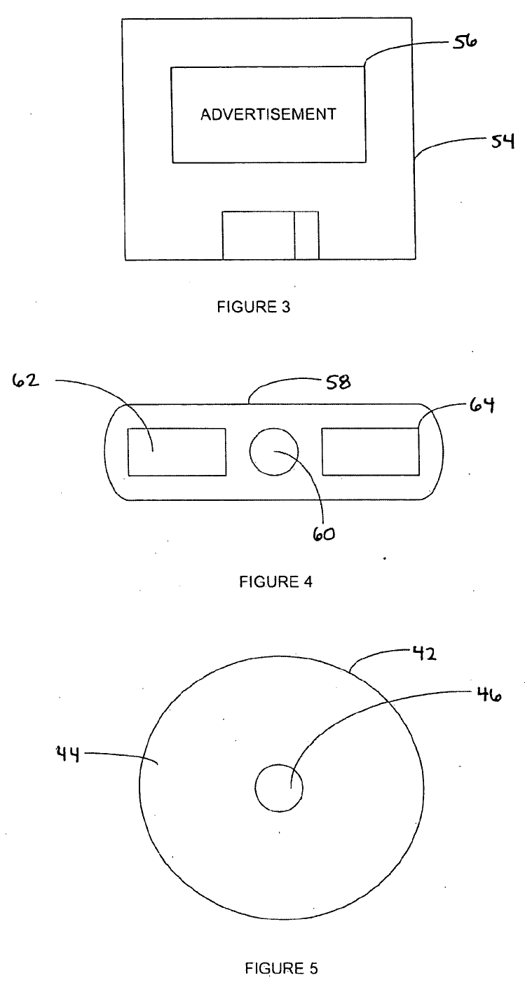

In an alternative embodiment of the present invention, other media are used to link the advertisers with their customers. Referring to FIGS. 2-4, a memory stick 48 includes a memory end 50 and an advertising surface 52. As is common in the field and well-known by those having skill in the art, an advertisement can be affixed to surface 52 such as a label or engraved in surface 52.

A floppy disk 54 is another alternative to CD 42. An advertising label is affixed to a surface 56 in a similar manner to surface 52. An electronic business card 58 is yet another alternative to CD 42. Card 58 includes a standard aperture 60 that allows card 58 to be inserted into a standard CD player and read. A first advertising surface 62 and a second advertising surface 64 provide means for advertising.

In addition to the advertising directly on surface 44 of CD 42 or placing electronic advertisements on CD 42, an advertisement 66 is also affixed or printed on an outside surface 68 of a CD sleeve 70. CD 42 is inserted into opening 72 formed in sleeve 70. Advertising is also placed inside a viewable area 72a of opening 72, in addition to a backside 72b of sleeve 70. Other carrier cases for CD 42 may also contain advertisement surfaces, such as under a flap or inside a book-style carrier.

In an Internet advertising system 74 illustrated in FIG. 7, Internet advertising is marketed by physically soliciting local business communities 76 within each franchise boundary. A separate sales staff located in each satellite office 24 builds the local business cooperatives. CDs 42 are distributed directly from the local advertisers' place of business, offered for sale to the public, or delivered to the consumer.

After receiving or purchasing CD 42, a person inserts CD 42 into a personal computer 78 that is connected to the Internet. In particular, CD 42 is inserted into an optical drive 80, or alternatively floppy disk 54 is inserted into a floppy disk drive 82. A communication link 84 connects the person to web portal 10 that accesses a corresponding database 86. Database 86 is a large-scale, high-traffic transactional database designed for high-end applications (e.g., Oracle™, SQL Server™, etc.). Consumers may use other means for accessing database 86 including PDAs and other similar technology.

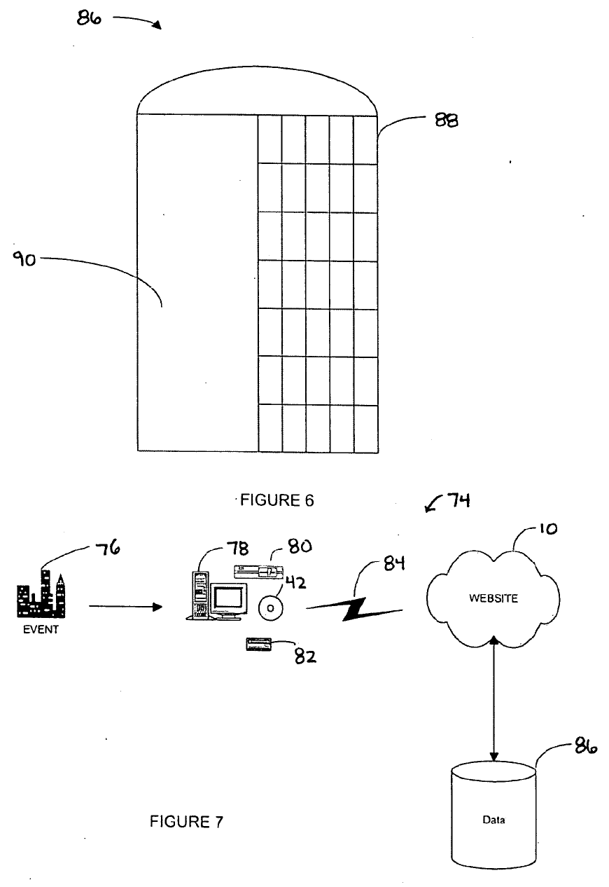

CD 42 contains a unique “key” or code that is transmitted to database 86 through portal 10 over communication link 84. As illustrated in FIG. 6, a particular advertisement 88 linked to the demographics of a person associated with the key or code will be displayed on portal 10. For example, if a person received CD 42 at a conference on planning a wedding, it is likely that the targeted advertising will contain a stored ad 90 on local bands, caterers, cake designers, and formal dresses as opposed to a listing of the local singles events.

As illustrated in FIG. 11, an advertising headquarters includes a product research and development team 92, a marketing department 94, a CD replication facility(s) 96, a graphics department 98, regional managers 100, all necessary administrative personnel 102, headquarters personnel 101, and a legal competitive research department 103.

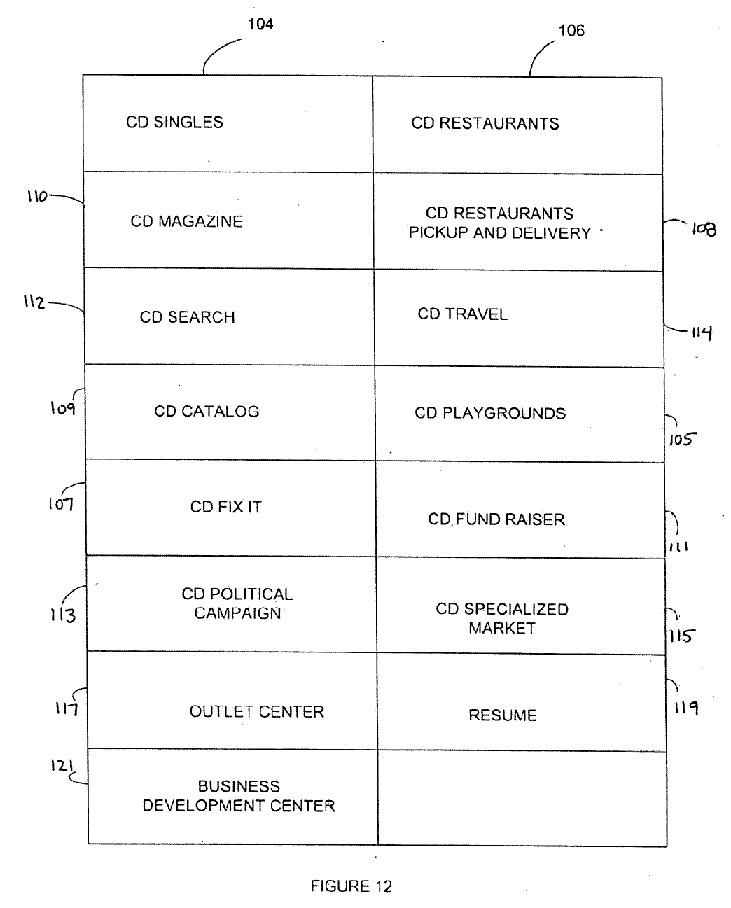

Referring to FIG. 12, product research and development team 92 is responsible for developing and enhancing a set of products included in portal 10. These products include a CD Singles 104, CD Restaurants 106, CD Restaurants Pickup and Delivery 108, CD Magazine 110, CD Search 112, and CD Travel 114. Other products include CD Playgrounds 105, CD Fix It 107, CD Catalog 109, CD Fund Raiser 111, CD Political Campaign 113, CD Specialized Market 115, Outlet Center 117, Resume 119, and Business Development Center 121.

Regional managers 100 monitor their territory for best cross breeding practices. Managers also set pricing in their territory for all advertising packages.

Graphics department 98 is responsible for layout and design of all web sites 10 and all CDs 42, labels and sleeves. They will also be responsible for designing the layout for web sites, the layout for a Business Development Center and the layout for advertiser web sites hosted by web portal 10.

CD replication facility 96 is responsible for replicating CDs 42, the label on the CD and the sleeve. Replication facility 96 is also responsible for ensuring the CDs 42 are shipped.

The Headquarters is responsible for establishing new franchises and the administration of franchise sales and marketing results.

Legal and Competitive Research is responsible for ensuring that the system remains unique, with a competitive advantage in the marketplace. Legal will be responsible for monitoring all existing and future markets for copy write infringements, taking legal action where required. Competitive Research will be responsible for watching all markets for any sign of any idea that may be forming in the market which would undercut market strategies in whole or in part.

Using advertising system 74, advertisers are able to present advertisements to a highly targeted audience in a variety of venues and from a variety of product lines. System 74 achieves economies of scale through the ability to present a common, targeted message to the same audience as that audience interacts with CD 42 directly and/or web site 10.

Local, national, and international companies have the opportunity to be presented to a local highly targeted client base, bridging the gap between virtual reality and a brick and mortar establishment. Any business can efficiently and cost effectively advertise to a highly targeted audience. The audience can be targeted by different activities, ages, sex, lifestyle and nationality.

Unsolicited advertising will be filtered by system 74 to avoid any form of junk email, junk instant messages, unsolicited advertising placed into online chat rooms and pop up advertising. In this regard, advertising is unobtrusive to the users of web site 10 and CDs 42.

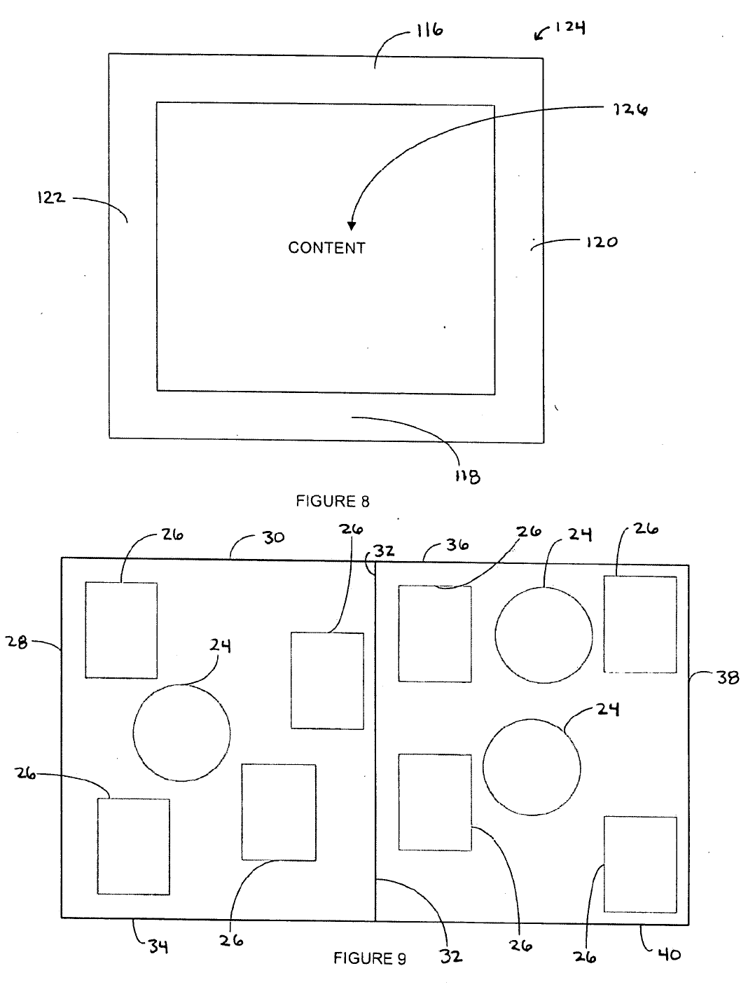

Referring to FIG. 8, advertising in the form of banners and/or buttons appears only on a top margin 116, a bottom margin 118, a right margin 120 and a left margin 122 of a screen 124 of website 10. Content is displayed in a middle portion 126 of screen 124. System 74 does not use bright, flashing ads that are obtrusive to the users.

In the preferred embodiment of the present invention, the advertising contains direct links to the advertiser's web site. The user clicks the advertisement and is redirected to that advertiser's web site by opening up a new browser window.

System 74 provides space on its own servers for companies that wish to have a new or different web site. This site will not be capable of doing business transactions.

System 74 includes four advertising options: Platinum, Gold, Silver, and Bronze. The options vary in ad placement and are priced accordingly.

### Platinum Advertising

Platinum refers to the space available on CD sleeve 68. This highly visible space will be reserved for businesses with a product that has a broad appeal to a majority of its customers' demographics. Generally only one advertiser will be on a CD sleeve for a CD Singles release; however, other product lines may have more than one advertiser on the sleeve.

### Gold Advertising

Gold refers to advertising messages 90 that are stored in database 86 and are available for interactive display on the user's computer screen. The same ad can be presented to customers of various product lines.

The Gold advertising package is what system 74 uses to build its main base of advertisers in which to populate all online screens with advertising messages and to capture and dominate the Internet advertising market.

Gold advertising is the most flexible advertising package and it offers the advertiser the greatest opportunity to get their message to a highly targeted audience. Recommended advertisers in the cross breeding sections of the individual product lines will enhance the ability of system 74 to target the audience. Advertising messages can be added, removed or changed at any time.

All Gold package advertisers are automatically placed into a standard directory that system 74 provides free of charge.

All Gold package advertisers have the opportunity to offer coupons or other incentives directly from website 10 through system 74.

System 74 also provides a small button advertisement for coupons for each user's local area.

Product line: There is a base price for advertising per product line. The more widely used product lines commands a higher price. System 74 includes strategic pricing plans for advertisers that choose more than one product line.

Markets: System 74 charges more for Gold advertising space in markets that show a higher demand for product lines.

Time: System 74 sells several different time frames for an advertisement to display on a screen. As an example, the advertisement can display on the computer screen for ten, twenty or thirty seconds. Longer time frames are billed at a higher rate.

Interval: System 74 includes several different intervals in which advertisements can be displayed. As an example, ads can be displayed up to four times, up to eight times or up to twelve times an hour. The advertisement interval will determine the price.

Time Slots: Product lines will have peak usage and off peak usage hours. Usage varies between product lines and it may vary within different age groups using CD Singles 104. System 74 determines and charges more for advertising during peak usage hours. For example, higher fees are incurred for advertising for CD Restaurants Pickup and Delivery 108 between the hours of 4:00 PM and 8:00 p.m. and between midnight and 2:00 a.m. CD Single's age group 18-21 peak hours are between 9:00 p.m. and midnight while CD Single's age group 14-17 peak hours are between 3:00 p.m. and 8:00 p.m. during the week and then extended hours on the weekend.

If a user of system 74 scrolls to different web pages on site 10, advertisements that have not timed out will follow the user to new web pages on site 10 until the paid time for that advertisement has been met.

### Silver Advertising

Silver advertising is part of the content of the CD 42 itself, and the advertisements are displayed to the user of system 74 on site 10 as soon as CD 42 is placed into computer 78, even without a connection to any web site. Like Platinum advertising, Silver advertising is visible for as long as the customer keeps using CD 42.

The charge for Silver advertising is a one-time fee per CD release, similar to the billing of Platinum advertising, except that when the product line CD contains all the information the user needs, and does not require a connection to site 10, Silver advertising will be charged at premium rates.

### Bronze Advertising

Bronze advertising is printed directly on label 66 of the CD 42. The advertisement appears to the user as soon as CD 42 is taken out of sleeve 70, before the user places CD 42 into computer 78. Bronze advertising is visible for as long as the customer uses CD 42. The charge for Bronze space will be a one-time fee per CD release.

Package Advertising

System 74 uses the space on all packaging used to ship or hold more than one CD to promote system 74 and site 10 and/or product line.

Banner Advertising

System 74 offers conventional Internet Banner Advertising packages that are directed towards companies that do not have to rely on or take advantage of system 74's proprietary advertising method that allows for geographical boundaries for Internet advertising.

Statistical Information

System 74 accumulates statistical information and provides detailed reports to advertisers containing, but not limited to, ad display frequency, geographical location of viewers, number of times the ad appeared per product line release, user demographics and various other statistics. Demographic statistics are tracked and logged using technologies that are well-known to one of ordinary skill in the art.

System 74 also accumulates statistical information on sales and usage of each product line. This information is used to determine fees for each advertising package for each franchise market.

### Product Lines

As illustrated in FIG. 12, product lines include Singles 104, Restaurants 106, Restaurants Pickup and Delivery 108, Magazine 110, Search 112 and Travel 114. Each of the products includes a description, set up requirements, business cross-breeding to identify highly targeted advertising opportunities, and product distribution requirements.

CD Singles

Singles 104 is a local, national and international online singles social and dating scene that extends beyond the Internet to reach its audience. Advertisers can target specific audiences, selecting one or more of system 74's advertising packages, maximizing their advertising and product exposure.

All singles client biographies are assigned an access code based on geographical location, category and age group. Up to 300 singles contain the same access code. This group of 300 singles are all assigned to the same release of CD Singles 104 within their geographical location. Alternatively, a CD may contain more than one category with a unique code for each.

Each release of CD Singles 104 is assigned one unique access code that communicates directly with database 86 via website 10 in system 74 which client bios to display. All singles with a matching access code will belong to this particular CD Singles 104 release and are the clients that populate the screen display when the customer who purchased or was given CD 42 inserts it into their computer 78.

When a CD Single 104's release reaches the 300 client threshold, a new CD of the category and age group will be released for distribution. New clients will be assigned the same access code as the newest release. The new release does not cancel out previous versions of the category.

| Categories: | Age Groups: |
|---|---|
| Woman seeking men | 14-17 |
| Woman seeking woman | 18-21 |
| Men seeking women | 22-25 |
| Men seeking men | 26-29 |
| Nationwide woman seeking men | 30-34 |
| Nationwide men seeking woman | 35-39 |
| Nationwide woman seeking woman | 40-44 |
| Nationwide men seeking men | 45-49 |
| | 50-55 |
| | 56-60 |
| | 60-above |

System 74 targets ethnic communities directly by offering CDs exclusively to various ethnic backgrounds. This service is offered from the bio form page on site 10. The Ethnic CDs are distributed in the local communities in the same manner as all other CD Singles 104. This encourages participation within these communities thereby increasing revenue from local ethnic business communities. Regional management and franchise personnel assess their territories to determine what ethnic CDs to offer.

CD Singles 104 are distributed within geographical boundaries. Age Groups 26-29 and above, all Categories, can encompass a larger boundary area and can cross state lines.

Age groups 14-17, 18-22 and 22-25 are distributed in smaller geographical areas. Larger cities are a complete geographical area for this age group, and some large cities may need to be further subdivided into more than one geographical area (e.g., the 14-17 age group). Age group 14-17 is less mobile and requires consideration for the smallest possible boundary area.

Clients are able to choose placement on the National and Global CD Singles. They are given the option of placement when the particular bio form is completed.

In the preferred embodiment of the present invention, CD Singles 104 is an international product and system 74 includes producing CDs in the applicable language either by direct translation or utilizing electronic translation technology as is well-known by one of ordinary skill in the art.

System 74 initially entices people through local advertising to sign up to participate on CD Singles 104. Clients fill out their personal information using the bio form on site 10. Clients have the option of uploading one or more personal pictures. New clients are placed onto the newest version of their chosen categories by age group.

When a CD customer who is not already a client of system 74 CD Singles 104 chooses to communicate with a client, they have a choice of either filling out a bio form or a free form message enabling a customer to pass their personal information to the client. If the customer chooses to fill out a bio form, they are asked if they would also like to become a client of system 74 CD Singles 104 and are placed on a future CD for selection.

System 74 passes messages from customers to system 74 clients until the client and the customer decide to communicate outside of website 10.

Clients have an additional option of uploading voice and video onto website 10 for personal bios or to correspond with other system 74 clients or CD customers.

CD customers can also pass messages to clients by uploading voice and video. Clients may change their Bio and pictures at anytime.

All new client bios and all changes to existing client bios are filtered before accepted (e.g., obscenity checks, etc.). In this regard, system 74 also edits other information from the bio form to ensure proper representation on website 10.

System 74 automatically assigns each new client an age group. Active clients are automatically relocated to the next age group when they no longer meet the criteria for their current age group.

Singles of the appropriate category and age group will populate the customer's screen 124 on website 10. There will be approximately 10 bios per screen. Customers may choose to populate and display only CD Single's clients that have registered as of a specific date, only those bios that have a picture included, or selecting specific religions or ethnicity. System 74 allows a user to apply complex filtering to screen the available bios for display based on technology that is well-known in the art allowing for flexibility in how client Bios will be selected for display.

A customer may also use system 74 to register for online CD Singles 104 Subscription Service. System 74 processes the online subscription and payment through website 10. The customer is assigned an access code via email by system 74 and accesses the online CD Singles 104 without purchasing a CD. The customer has a choice from several different subscription packages.

Within a particular period of time, older releases of CDs will age off of database 86. Inactive clients are also filtered off database 86. Any client who does not respond to messages from website 10 visitors or clients for a particular period of time are deactivated. Any client that is reported for inappropriate interactions on website 10 is also deactivated.

CD Singles 104 releases will age and be deactivated when approximately 25% of the clients on that release have become inactive. System 74 populates newer releases of a particular category and age group with the active clients from the release being deactivated. Active clients with the oldest registration dates will populate the newer releases first. All active clients being relocated to newer releases will be notified of the change through email via system 74. The email also recommends that the customers update their bios.

Clients have the option to put their bio on hold. Bios can still be displayed on the screen for their specific release along with a message stating that the single is currently on hold.

Following deactivation, all client bio information is stored in an archive database. This enables system 74 to repopulate the bio form for easy editing if, in the future, a client wishes to become an active member. The archive database contained within database 86 also stores which category the client was in before deactivation, thereby enabling the client, who may have had a different bio in more than one category, to choose which bio to edit and reactivate.

### Advertising

Platinum advertising for CD Singles 104 release is a one-time fee per category and age group within any region.

Platinum advertising for a CD Singles 104 release includes a button or banner on top 116 of each page on screen 124 on website 10 for the category and age group paid for by the advertiser (FIG. 8).

CD Singles 104 is a natural for advertising presentation to a targeted audience, based on singles category and age group.

Age group 14-17, in all categories, can be crossbred with advertising for concert tickets, teen clubs, music stores, music download site, movie theaters, all stereo equipment shops, video gaming stores and arcades, cell phone providers and pager companies, shoe stores, hip clothing stores such as Abercombie and Fitch®, body piercing and tattoo shops, hair products, hip places to get hair cuts, used auto dealerships, educational software and other educational shops, musical instrument stores, etc.

Age 14-17 Woman Seeking Men is also crossbred with advertising for businesses catering to the skateboarding industry and young men's clothing.

Age 14-17 Men Seeking Woman is crossbred with advertising for full service salons, products dealing with current pop stars, bead and jewelry shops.

Age group 18 through 60 and above in all categories is crossbred with night clubs and other social establishments, restaurants, sporting good stores, vacation spots, cruises, bowling alleys, casinos, auto dealerships, furniture stores, book stores, and movie theaters.

Men Seeking Woman and Men seeking Men are crossbreeding areas for men's clothing and shoe stores, sports related products and things that appeal to men in their respective age groups.

CD Singles 104 is distributed and sold at the counter of local convenience stores and local franchise offices, in addition to other local businesses. CDs 104 are also distributed at targeted events. Additionally, CDs 104 are available for purchase via website 10.

CD Catalog

CD Catalog eliminates print material and converts it to electronic commerce. CD Catalog services retailers, wholesalers, merchandisers, print catalogs and grocers. This product line drives consumers to merchandiser's Web sites, enhances or replaces print catalogs and prints inserts merchants currently insert into local new papers on a weekly basis. CD Catalog is environmentally friendly and replaces significant amounts of print advertising. Major benefits of CD Catalog are as follows. CD Catalog's CDs last longer than the print advertising they are replacing. It directs consumers to merchant's web sites continuously 24/7/365.

CD Catalog is significantly cheaper to produce than print advertising, easily maintained and significantly reduces costs of advertising. Merchants can direct consumers to their web site via the CD and then simply maintain their web site as they so choose, reissuing CD's periodically to an increasingly targeted audience.

CD Catalog is environmentally friendly. The amount of print advertising CD Catalog can eliminate is significant and along with the cost savings to the merchants, CD Catalog should be widely embraced by the business community. Merchants can entice customers to use their CD Catalog by offering incentives to those who use the CD.

Setup Details:

CD Catalog is set up in one of three ways.
1. The advertised products are displayed on the computer directly from the CD
2. The CD directs consumers to the Merchants.
3. The advertised products are displayed on the computer from the CD and also include a link to the merchant's web site.

The system captures as much of the production process as possible including web site hosting and maintenance. Electronic order processing, inventory control and billing services are also be considered by the system for CD Catalog Merchants.

If multiple businesses appear on one CD Catalog, e.g. the ValPak Savings, an index appears on the CD linking the consumer to the merchant's web site or products stored on the CD Catalog.

CD Deactivation:

CDs are deactivated for all web site and advertising for any Merchant who cancels their contract. A message is displayed indicating that “This Merchant is no longer supported by the system in your area” to any consumer who tries to link to the web site through a CD Catalog that has been deactivated. The consumer is offered a link to other Merchants in there area that advertise through the system.

Advertising:

The Platinum advertising package will always be reserved for the Merchants who contracted with the system for the CD Catalog.

No competitors will be advertised on a CD Catalog release under any of the advertising packages offered by the system.

When the user inserts this CD into their computer, the CD Catalog polls for an Internet connection. If an Internet connection is made, Gold advertisements will be presented to the consumer.

Business Cross Breeding:

The system profiles consumers based on the type of products in the Catalog. The system selects and displays advertisers based on this profile. Example: The CD Catalog Merchant is a grocery store. Most users of this CD would be woman between the ages of 25 and 50. Woman's clothing stores and cosmetics do not compete with a grocery catalog and make excellent advertisers for this CD. And electrical or plumbing supply company will cater more to professional men. Good cross breeders for these types of catalogs would be sports, hunting and fishing industries.

Distribution:

CD Catalog can be distributed much like print advertising is delivered today. Merchants can distribute the CD to their customers on site, insert them into local newspapers and/or mail them through the US Postal Service.

Secondary distributions points can be through local advertisers who have signed up to advertise on CD Catalog with Gold, Silver or Bronze advertising packages.

Special Notes:

Sales people for this product line will be recruited from the print industry.

CD Playgrounds

(Insert into Business Plan, Patent Application and Drawings, after CD Catalog, before CD Restaurants.)

CD PlayGrounds

CD PlayGrounds provides a safe, secure, entertaining and controlled environment for kids on the Internet, between the ages of 3 and 13. CD PlayGrounds offers a variety of entertainment activities, including educational topics, games, animated stories, chats and music, all aimed at the different age groups. Some themes are recurring, some are one time events offered for a specific period of time. Some themes are animated mini series. Children may interact with many activities, at varying skill levels.

CD playgrounds also supports homeschooling groups and assists these groups in coordinating and developing theme unit learning, field trips, social interaction opportunities, and the establishment of virtual schools via system 74.

System 74 creates and supports online characters that rival popular characters like Barney®, Blues Clues®, Dora the Explorer®, Bob the Builder® and market these characters in online themes and in the brick and mortar world. With CD PlayGrounds, the child communicates directly and personally with their favorite character(s).

Themes that will be offered include but not limited to,
Arts and crafts,
Educational games teaching math, spelling, foreign language, or any topic conducive to computer based learning,
Music, both listening and learning to play a variety of instruments,
Sports films, instructions, game plans, virtual coach and team,
Scouting activities and support,
Model car/plane/truck/vehicle activities,
Recurring activities such as a story time,
Video games,
Doll house.

Each CD PlayGrounds is assigned an access code for particular themes and age group.

CD Playgrounds offers children plenty of different free zones that they can participate in at anytime.

Advertising is concentrated on the sleeve of the CD, on the CD label and on the menu area once the CD is placed into the computer. Gold advertising is available when kids first enter and exit the CD Playground's site. Once in the site and interactive with any Playgrounds product, children are marketed to by the high quality entertainment characters developed by, purchased or leased by system 74. These characters are transformed into real world products that children want and will enjoy.

CD Playgrounds is crossbred with children's items across the board. Children's toys, movies, any quality item can become a featured item.

CD Playgrounds is sold to the public at any location that carries kids products.

CD Restaurants

CD Restaurants 106 caters to the restaurant industry. System 74 organizes restaurants that have similar atmosphere/ambiance and advertise them on the same CD. This allows customers who frequent these restaurants to sample other restaurants of similar atmosphere or cuisine. Participating on CDs 106 allows restaurants the opportunity to broaden their clientele base. Crossbreeding the restaurants with local targeted advertising will increase exposure of the advertiser's products.

Each CD 106 contains information on 8 to 15 restaurants. The menu for each restaurant is displayed directly from CD 106 along with general information about the restaurant, contact information and promotional offers. If the restaurant has a website, a link will appear on CD 106, providing the restaurant with increased website traffic. If a restaurant does not have a website, system 74 can create and host a site.

CD 106 includes a table of contents listing each restaurant. All links from the table of contents link directly to each restaurant's information contained on CD 106. The Internet link for each restaurant's website is located in each individual restaurant's area on CD 106.

The last entry in the table of contents is a Gold Star representing all restaurants that have signed up with system 74 after a version or release of CD Restaurants 106 has been replicated and distributed. Information on new restaurants is stored on website 10 and is available by clicking on the Gold Star.

Sleeve 70 for CD 106 is reinforced for convenient and easy storage, insuring continual use. Sleeve 70 includes a magnet (not shown) or some other adhesive securing means affixed to surface 68 to allow CD 106 to be secured to another surface (e.g., a refrigerator) for prominent placement in the home.

In the preferred embodiment of the present invention, system 74 creates CD Restaurants 106 by categorizing restaurants into one of many themes to include, but not limited to, the following:

Fine dining; Pub and grill; Young singles atmosphere; Family owned; Indonesian; Mid-age singles atmosphere; Italian; Greek; Sushi; Indian; French; Mexican; Chinese; German; Japanese.

CD Restaurants 106 is reissued when a particular percentage that is individually determined for each category and each franchise area of the 25,000 CDs have been distributed. All restaurants from the CD being deactivated will have to re-contract with system 74 for inclusion in the new release.

All restaurants that were listed under the Gold Star are included on the main menu along with the other restaurants that contract to be on the new CD 106. Any other restaurants, which were not on the prior release of CD Restaurants Pickup and Delivery 106, can sign up and be placed on the main menu of the new CD 106.

The older version of CD Restaurants 106 remains active even after the newer version of the CD 106 is distributed and until website 10 detects little usage of the old version of CD 106. After system 74 deactivates the older version of CD 106, no advertising from the gold package is channeled to the old version of CD 106.

A message stating that this version of CD Restaurants 106 has been deactivated appears along with a list of Restaurants that are on the newer version of the CD 106. The message will list all the restaurants in the user's region where the user may obtain the newest version of CD 106.

### Advertising

Platinum advertising for a CD Restaurants 106 release is a onetime fee for each group of restaurants that are all placed on one CD 106.

When the user inserts CD 106 into their computer 78, CD 106 searches for an Internet connection. If an Internet connection is made, system 74 channels gold advertising to the user.

Stores at malls that are located near the restaurant, movie theaters, electronics stores, home builders, home remodeling companies, painters, carpet installers, lawn services, rental property companies, heating and air conditioning companies, interior decorators garden centers and other services that have to do with the home are crossbred with the restaurants product line.

Additionally, outdoor recreation (e.g., mini golf courses), weekend getaways and other vacation industries are also targets. Electronic stores, clothing stores, grocery stores and even other restaurants also fit on CD 106.

CD Restaurants 106 is distributed on location of each restaurant that is represented on the CD 106. Distributing CDs 106 directly to the people already at the restaurant ensures the most accurate rate of return for their respective markets. Distributing CDs 106 at the location determined by the particular advertisers is also an option, and may include travel agencies, hotels/motels, convention centers, Welcome Wagon and realtors.

CD Restaurants Pickup and Delivery

CD Restaurants Pickup and Delivery 108 caters to an array of local neighborhood restaurants that offer pickup and delivery to their customers.

The main focus for CD Restaurants Pickup and Delivery 108 is the Chinese and pizza pickup and delivery restaurants. Any other type of restaurant that offers pick up and deliver (e.g., some specialty restaurants such as KFC restaurants) also fit onto this CD 108 product line.

The menu for each restaurant is placed directly on CD 108 along with general information about the restaurant and contact information. If the restaurant has a website, a link will appear on CD 108, thereby providing the restaurant with increased website traffic.

CD 108 includes a table of contents and all links from the table of contents link directly to each restaurant's information contained on CD 108. The link for each restaurant's website is located in each individual restaurant's area on CD 108.

The last entry in the table of contents is a Gold Star which represents all restaurants which have signed up with system 74 after a version of CD Restaurants Pickup and Delivery 108 has been produced and distributed. Information and menus on new restaurants are stored on website 108 and this information is available to those users who click on the Gold Star.

CD Restaurants Pickup and Delivery 108 will be reissued when a particular percentage of the 25,000 CDs 108 have been distributed. All Restaurants from the CD being deactivated have to re-sign with system 74 for inclusion in the new CD 108 release.

All restaurants that were listed under the Gold Star will be included on the main menu along with the other Restaurants that chose to be on the new CD 108. Any other restaurants that were not on the prior release of CD Restaurants Pickup and Delivery 108 can contract with system 74 to be included on the main menu of the next CD 108 release.

The older version of CD Restaurants Pickup and Delivery 108 remains active even after the newer version of CD 108 is distributed and until website 10 of system 74 detects a low level of usage of the old version of CD 108.

After system 74 deactivates the older version of CD 108, no advertising from the gold package is channeled to the old version of CD 108. A message stating that this version of CD Restaurants Pickup and Delivery 108 has been deactivated appears along with a list of restaurants that are on the newer version of CD 108. The message lists all the restaurants in the user's region where the user may obtain the newest version of CD 108.

### Advertising

Platinum advertising for a CD Restaurants Pickup and Delivery 108 release is a one-time fee for inclusion in each group or category of restaurants that are all placed on one CD 108. A restaurant that offers take out or delivery services on CD 108 is not an advertiser on the sleeve of CD 108.

CD 108 polls for Internet presence when the user inserts CD 108 into PC 78. If Internet presence is detected, system 74 channels gold advertising to the user via website 10 through ads 90 stored in database 86.

Home builders, home remodeling companies, painters, carpet installers, lawn services, rental property companies, heating and air conditioning companies, interior decorators garden centers and other services that are related to the home are targets for this product line. The crossbreeding is similar to that described above in relation to CD Restaurants 106.

CD Magazine

There is an inherent problem with the current distribution of paper magazines. Unfortunately, by the time the information is gathered and the magazine is distributed, the information is already dated. The majority of magazines are printed either on a weekly or monthly basis. They consume a lot of resources and the cost for printing and distribution is enormous.

CD Magazine 110 includes a variety of daily, weekly and monthly periodicals accessed through website 10 via CDs 110. CDs 110 flash the magazine products in front of the public's eyes in the brick and mortar world and entice them to access website 10 for access to CD Magazines.

CD Magazines included on CD 110 are interactive as opposed to their real world counterparts. Magazines on CD 110 include real time information including web cam reporting that is available live and/or archived for subscribers to CD Magazine 110. News and information can be presented “live” as the story unfolds.

For example, consider CD 110 related to sports that includes content directed to covering the NCAA college football and the NFL. For hunting and fishing Magazines. CD Magazine 110 allows subscribers to download streaming or still shots of their bounty along with a small caption. System 74 also provides a link to this portion of CD Magazine 110 that allows non-subscribers to view these public videos and still photos.

System 74 supports reporters equipped with web cams at major colleges to cover sports teams in depth and give subscribers a comprehensive view of the future potential athletic stars. The reporters also capture as much of the sideline and on field action as will be permitted by league rules during games including exclusive interviews. Leagues include NCAA, NFL, WNBA, etc. In the preferred embodiment of the present invention, system 74 supports all sports and leagues.

System 74 gains this access by securing exclusive rights deals for Internet reporting. This content is offered via system 74 over website 10 either live and archived. System 74 also includes web cams attached directly to key players and displays the action live and archived along with the sounds on the field. Live coverage of practice and inside the locker room is also available to subscribers.

System 74 hosts CD Magazine 110 on website 10. Consumers who purchase the CD Magazine 110 of their choice have access to that particular periodical. In the preferred embodiment of the present invention, CD 110 only stores the key or code for access to the specific magazine on website 10.

Therefore, system 74 avoids the use of pop up advertising or junk mail to reach the consumer. CD 110 also serves as a base for local advertising. Once market share has been achieved, system 74 will transfer the usage base from CDs 110 to subscription services available on website 10.

Users also access content related to CD Magazines 110 through hand-held devices (e.g., PDAs) and other non-conventional wireless devices. In fact, all services and products available via system 74 may be accessed through PDAs and other non-conventional wireless devices.

Content for magazines and advertising is also targeted to individual users based on the person's geographic and demographic information obtained and retained by system 74 (e.g., zip code, type of magazine subscription, age, etc.).

Topics for CD Magazine 110 include: Health; Business; Politics; Men's Fitness; Autos; Technology; Woman's Fitness; Computing; Investing; Cooking; Electronics; Sports; News; Entertainment; Hunting; Family; Clothing; Fashion; Teens; Children; Music; Arts and Humanity; Interior Design; Horticulture; Fishing; Photography; Tourism; Wine; Fishing.

### Advertising

Platinum advertising for CD Magazine 110 release is either a one time or monthly fee, and advertising will include promoting the magazine itself.

CD Magazine 110 is another natural vehicle for crossbreeding onto CDs. Advertisers are local and national companies that cater to the same theme as the magazine. Other advertisers are companies that cater to the demographics of the users that typically purchase the different types of magazines. Local company's ads are displayed only to their own geographical area unless they desire to expand their territory.

CD Magazine 110 is sold to the consumers directly out of local satellite offices 24. Other distribution points are convenience stores, drug store chains and local businesses that cater to the same theme as each particular CD 110. All advertisers for any CD Magazine 110 are also distribution points.

System Business Development Center

System 74 includes hosting a Business Development Center (BDC) on website 10. At the BDC, individuals or businesses develop basic websites, according to predetermined guidelines within system 74, to market and sell their products and services. System 74 performs targeted, internal advertising, presenting BDC clients to targeted users of other product lines (e.g., a link to System Outlet Center).

CD Fix-It

CD Fix-it is targeted at the largest segment of communities apt to use it, people that don't know how to fix things. CD Fix-It describes everything on an elementary level including pictures, how to repair or build things, where to go to get materials, including the tools and pictures of what they all look like, with video and audio to enhance instruction.

CD Fix-It topics are varied, not limited to:
Plumbing—Leaky faucets, toilet, outside faucets, installing a new faucet, hot water heaters.
Electrical—installing an outlet, adding a circuit, replacing fuses, installing ceiling fans.
Automotive repair and maintenance, tune ups, breaks, oil changes, replacing windshield wipers, general maintenance.
Building decks, outbuildings.
Remodeling any room or structure.
Replacing windows, siding, shutters, gutters.
Painting, wallpapering and tiling.
Assembling furniture.
Furniture refinishing.
Carpentry

The headquarters will hire knowledgeable professionals and use their expertise for content and development of each CD Fix-it topic.

Each CD Fix-It CD stores a key code. When an Internet connection is made to system 74, the key code is used to bring up all text, audio and pictures stored on DigitalMarket's web site. In addition to the stored key code, most CD Fit-It's also contain all information found on the web site enabling those people without an Internet connection to use CD Fix-It.

When the user inserts CD Fix-It into their computer and an Internet connection is found, Gold advertisements will be presented to the consumer. Advertising is targeted to each repair topic. The consumers are crossbred with local equipment and tool suppliers that fit the CD Fix-it topic. Secondary cross breeders concentrate on sports and hunting.

CD FundRaiser

CD FundRaiser markets to national headquarters, local fund raising organizations and local chapters of national fund raising organizations. CD FundRaiser allows these organizations to distribute information in the most cost-effective manner by placing their message on a CD. In addition, system 74 allows a targeted audience to make contributions right from the privacy of their home or office.

Advertising includes a variety of businesses including radio, TV stations, newspapers, supermarket chains, pharmacies and service organizations.

Other potential advertisers depend on the particular event. For example, if the fundraiser has a broader appeal to women, advertisers of woman's clothing, cosmetic firms, home products and other women's organizations are potential advertisers.

CD Political Campaign

CD Political Campaign accommodates political candidates running for mayoral, statewide or national races. The CD allows a candidate or national political party to approach targeted voters directly in the privacy of his/her home or office, cost-effectively and without media bias. In particular, the CD will enable the voting public to make a campaign contribution with a simple click of a button after linking from the CD Political Campaign directly to the candidate's website contribution page.

Any association, union or organization that supports the candidate may (with the candidate's or party's authorization) put their endorsement message on the CD sleeve, label or stored on the CD itself. This would include, but not be limited to: political organizations, PAC's (to the extent of the law), Police Associations, Fire Fighter Associations, teachers' unions, special interest groups and lobbyists.

System Resume

Website 10 allows people to post resumes, identifying the type of work they are seeking, to highlight key skills they possess, and to identify skills they are seeking to perform/utilize. Businesses seeking employees will be able to utilize the web site to target their search toward the type of work and/or skills the applicant identified.

System Outlet Center

Website 10 includes an Outlet Center that is a market place for consumers and merchandisers to buy and sell goods.

System 74 establishes numerous categories to encompass all merchandise. The merchants select the category that best describes their product, set prices and conduct the sales including pictures and descriptions of products.

Local, national and international advertisers are solicited and advertisements are placed into the categories they already cater to.

CD Search

CD Search provides via system 74 complete, comprehensive and well-organized searches on thousands of topics that have a broad based appeal. CD Search capitalizes on the most widely used spectrum of search topics and leaves the less-used and undesirable topics for the free search engines.

System 74 utilizes demographics to display increasingly targeted search results (e.g., displays a local yarn shop first as a search result for ‘yarn supplies’).

CD Specialized Market

CD Specialized Market includes those markets where a single business entity has created and captured a market that has broad based appeal and is so unique in nature that system 74 cannot capture it with existing product lines.

CD Specialized Market is a template that allows franchises to seek out, solicit to and create an enticing marketing package, unique to the way system 74 conducts business. Examples include sports training centers, convention and party outfitters, and manufacturers of unique products.

Advertising for each Market is a unique opportunity and can be presented to a targeted audience of businesses and their clients. Convention outfitters, event planners, presenters and speakers, and event suppliers form an interdependent community of businesses that can be commonly promoted. They all have a common customer base and are presented in tandem with one another.

CD Talent

Website 10 includes talent content that is available to an international audience, allowing anyone, anywhere, to upload a video and/or audio performance and let other people view and vote. Users of talent content on website 10 select and listen to top voted talent in any category of their choosing. The performance(s) are also played in the background while the user performs other computer tasks.

Advertising is targeted to the performer and to the listener/viewer. Because the user may only be listening to performances, Gold advertising packages include audio clips.

CD Travel

Today with the ease of connection to the Internet, consumers are planning their own vacations and travel, be it to a different country, state, a week at the beach or a business or social convention. There are many web sites, which cite the lowest hotel/car rental and airfares, but these sites are often confusing and time consuming. On the other hand, travel agencies offer to do the work for the traveler, but they are driven by rebates and behind-the-scene financial arrangements.

Using the Internet or a travel agent, the consumer does not get complete information of the geographic area being researched. The Internet serves up hundreds/thousands of irrelevant sites, which take too much time to view, and the travel agent is calculating the bottom line. CD Travel presents the traveler with a well-organized view not only of the vacation area and attractions in the area, but also offers alternative sites of similar areas based on the consumers' interests.

CD Travel accommodates families, groups and individuals in planning their vacation and travel events and conventions. CD Travel provides complete and well-organized information to meet targeted interests. System 74 selects popular vacation areas and blends this content with local advertising.

### Internet Advertising System Architecture

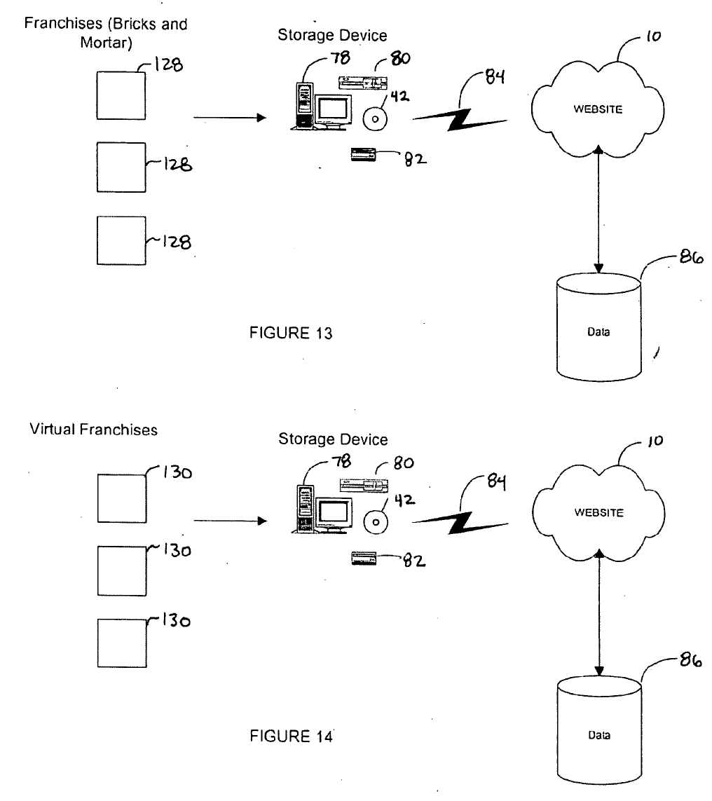

As illustrated in FIG. 13, advertising system 74 includes distribution of advertising on a storage medium (e.g., CD 42) by a customer interacting with a set of physical franchises 128 in the bricks-and-mortar world. Using this architecture, a customer obtains CD 42 from franchise 128 or some other location, plays CD 42 on personal computer 78, links with website 10 over communication link 84 and is exposed to various advertisements filtered by database 86.

In an alternative embodiment of the present invention, FIG. 14 illustrates a series of virtual franchises 130 that operate similarly to brick-and-mortar franchises 128, except that virtual franchises 130 exist without any geographical boundaries such as within the internet.

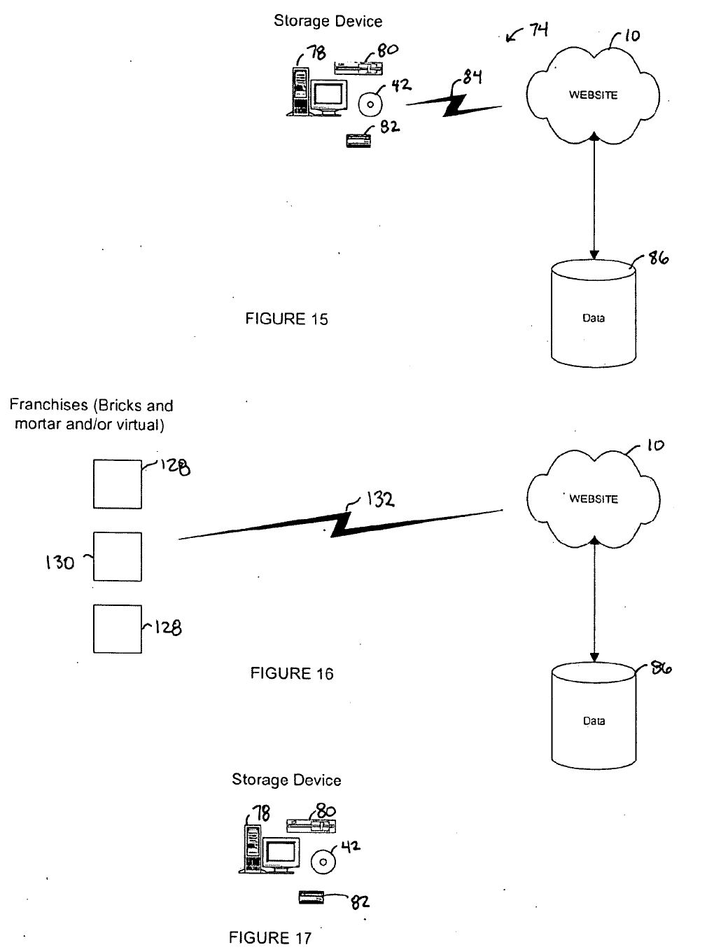

In yet another alternative architecture, FIG. 15 illustrates advertising system 74 without the use of any franchises 128 or 130. In this architecture, the customer links directly with database 86 via CD 42 that is not linked to any franchise.

FIG. 16 illustrates another architecture that eliminates a customer using a CD to interface with website 10. In this embodiment, franchises 128 and/or 130 are used to communicate directly with site 10 over a communication link 132. Advertising is distributed via site 10 by database 86 to franchises 128 and/or 130.

FIG. 17 illustrates a stand-alone architecture with a customer receiving targeted advertising directly from CD 42 without any interaction with site 10 and database 86. Additionally, the customer does not necessarily interact with any franchises 128 or 130.

The scope of the application is not to be limited by the description of the preferred embodiments described above, but is to be limited solely by the scope of the claims that follow. For example, instead of distributing an electronic “key” or code to link a potential client in the brick and mortar world with the virtual world via system 74, any media that passes a key may be used (e.g., a note/card containing a written code that is manually entered by the user) without departing from the scope of the preferred embodiment of the present invention.

1. A method of advertising on the internet comprising the steps of:
distributing a key to a potential customer wherein the key is associated with at least one characteristic of the potential customer;
communicating the key to a website on the internet;
displaying a set of advertisements on the website to the potential customer based on the at least one characteristic of the potential customer associated with the key.

2. The method according to claim 1, wherein the key is electronically distributed to the potential customer over the internet.

3. The method according to claim 1, wherein the key is distributed on a storage medium to the potential customer in the bricks-and-mortar world.

4. The method according to claim 3, wherein the storage medium is a compact disk.

5. The method according to claim 3, further comprising the steps of:
dividing cities with geographical boundaries into separate zones, wherein at least one franchise is established in each of the zones; and
maintaining a set of sales personnel in the at least one franchise, wherein the sales personnel interact with at least one local business to sell advertising.

6. The method according to claim 5, wherein the key is distributed to the potential customer at the at least one franchise.

7. The method according to claim 1, wherein the website includes a set of products.

8. The method according to claim 7, wherein the set of products includes at least one of a singles product, a restaurants product, a magazine product, a restaurants pickup and delivery product, a search product, a travel product, a catalog product, a playgrounds product, a fix-it product, a fund raiser product, a political campaign product, a specialized market product, an outlet center product, a resume product, and a business development center product.

9. A system for advertising on the internet comprising:
a franchise building in the bricks-and-mortar world, wherein the franchise distributes a key to a potential customer wherein the key is associated with at least one characteristic of the potential customer;
a communication link to the internet, wherein the key is communicated by the potential customer to a website on the internet;
an advertisement database connected to the website, wherein a set of advertisements stored in the advertisement database is displayed on the website to the potential customer based on the at least one characteristic of the potential customer associated with the key; and
a selection device integrated into the website, wherein the selection device evaluates the key and selects the set of advertisements to be displayed based on predefined criteria.

10. The system according to claim 9, wherein the predefined criteria includes demographic statistical information associated with the potential customer.

11. The system according to claim 10, wherein the key is distributed to the potential customer on a storage medium.

12. The system according to claim 11, wherein the storage medium is a compact disk.

13. The system according to claim 11, wherein the key is electronically distributed to the potential customer over the internet.

14. The system according to claim 9, wherein each city is divided with geographical boundaries into separate zones, wherein the franchise building is in each of the zones, and a set of sales personnel in each of the franchise buildings in each of the zones interact with at least one local business to sell advertising.

15. The system according to claim 9, wherein the website offers a set of products including at least one of a singles product, a restaurants product, a magazine product, a restaurants pickup and delivery product, a search product, a travel product, a catalog product, a playgrounds product, a fix-it product, a fund raiser product, a political campaign product, a specialized market product, an outlet center product, a resume product, and a business development center product.

16. A system for advertising on the internet comprising:
a storage medium containing a key associated with at least one characteristic of a potential customer, wherein the storage medium is distributed in the bricks-and-mortar world to the potential customer;
a communication link to the internet, wherein the key is communicated over the communication link to a website on the internet;
an advertisement database connected to the website, wherein a set of advertisements stored in the advertisement database is displayed on the website to the potential customer based on the at least one characteristic of the potential customer associated with the key; and
a selection device integrated into the website, wherein the selection device evaluates the key and selects the set of advertisements to be displayed based on predefined criteria.

17. The system according to claim 16, wherein the predefined criteria includes demographic statistical information associated with the potential customer.

18. The system according to claim 16, wherein the storage medium is a compact disk.

19. The system according to claim 16, wherein each city is divided with geographical boundaries into separate zones, wherein at least one franchise building is in each of the zones, and a set of sales personnel in each of the at least one franchise buildings in each of the zones interact with at least one local business to sell advertising.

20. The system according to claim 16, wherein the website offers a set of products including at least one of a singles product, a restaurants product, a magazine product, a restaurants pickup and delivery product, a search product, a travel product, a catalog product, a playgrounds product, a fix-it product, a fund raiser product, a political campaign product, a specialized market product, an outlet center product, a resume product, and a business development center product.
